(19) United States
(12) Patent Application Publication
(10) Pub. No.: US 2014/0032280 A1
(43) Pub. Date: Jan. 30, 2014

(54) EMPLOYEE PERFORMANCE EVALUATION

(71) Applicant: UNILOC LUXEMBOURG, S.A., Luxebourg (LU)

(72) Inventor: Craig S. ETCHEGOYEN, Plano, TX (US)

(21) Appl. No.: 13/944,622

(22) Filed: Jul. 17, 2013

Related U.S. Application Data
(60) Provisional application No. 61/676,251, filed on Jul. 26, 2012.

(51) Int. Cl. G06Q 10/06

(52) U.S. Cl. CPC G06Q 10/06398
USPC 705/7.42

(57) ABSTRACT

Productivity of an employee is deduced from data representing the employee's usage of a computing device in carrying out tasks assigned to the employee in a number of usage sessions of computer-implemented applications invoked by the employee. Productivity can be represented as a measure of time spent by the user in one or more usage sessions of the computer-implemented applications during a given time period. Sessions can be grouped by time segments to determine the employee's productivity at various times. Sessions can also be group by categories of tasks to determine the employee's aptitude for various tasks and types of work.

This application claims priority pursuant to 35 U.S.C. §119(e) to U.S. provisional application Ser. No. 61/676,251, filed Jul. 26, 2012, which application is specifically incorporated herein, in its entirety, by reference.

### BACKGROUND OF THE INVENTION

1. Field of the Invention

The present invention relates generally to computer network services and, more particularly, to methods of and systems for evaluating performance of one or more employees of an organization.

2. Description of the Related Art

Macroscopic evaluation of employee performance is fairly simple: employees are typically given tasks and a schedule and whether the tasks are completed satisfactorily within the schedule is fairly easy to observe. A more microscopic analysis, however, is much more difficult. Examples of questions that are difficult to answer include the following: Why is one employee better than another at a given task? To which employee should a particular task be assigned for greatest efficiency? How can an employee's environment be modified to significantly increase her productivity?

Of course, a manager can ask an employee for her thoughts on those questions. However, the employee is unlikely to answer honestly as she may perceive that her job hinges on a satisfactory answer. A manager can observe an employee throughout the work day to witness directly the employee's work habits, but such observation can be disruptive to the employee and thereby skew the results. That is, if the employee knows that she's being watched, her actions that day are not likely to reflect her actual, typical work habits. Moreover, managers rarely have the time to passively watch an employee for an entire day.

What is needed is a way to accurately and unobtrusively evaluate typical work habits of employees to derive information that will allow for increased productivity of such employees.

### SUMMARY OF THE INVENTION

In accordance with the present invention, productivity of an employee is deduced from data representing the employee's usage of a computing device in carrying out tasks assigned to the employee. The data represents a number of usage sessions of computer-implemented applications by the employee. The productivity of the employee is determined by analysis of the sessions.

Generally, productivity can be represented as a measure of time spent by the user in one or more usage sessions of the computer-implemented applications during a given time period. For example, if the employee spent 48 minutes between 10:00 am and 11:00 am in usage sessions with one or more work-related, computer-implemented applications, the employee is determined to have been 80% productive during that hour.

Sessions can be grouped by time segments to determine the employee's productivity at various times. For example, grouping sessions and corresponding productivity measurements by time-of-day for multiple work days, a productivity profile of the employee for a typical work day emerges. Beyond time-of-day analysis, similar analysis can be performed to determine productivity patterns of the employee by days of the week, days of the month, and months and seasons of the year. In addition, changes in the employee's productivity over time can be measured.

The employee's productivity profile can be used to craft a work schedule for the employee that takes greatest advantage of the employee's natural productivity. For example, an employee that shows great productivity in the early morning and late evening can be given a split work day in the early morning and late evening with a long break in the middle of the day. In addition, collaboration between employees can be scheduled at times at which all involved employees are most productive.

Sessions can also be group by categories of tasks to determine the employee's aptitude for various tasks and types of work. Each of the computer-implemented applications is associated with one or more of a number of task categories. The task categories can be hierarchical to allow productivity analysis of the employee at various levels of detail.

Productivity for specific tasks can be measured in a couple of ways. In one, productivity is measured in the manner described above, e.g., percentage of time in a usage session of a work-related, computer-implemented application. For example, the employee may be 60% productive when performing tasks of one category and 80% productive when performing tasks of another category.

In another, productivity of a task is measured as an amount of time required for the employee to complete a task of a category. For example, the change log in a document representing a weekly status report prepared by the employee can indicate that the employee spent one hour and twenty-five minutes preparing the report. Productivity measured in this manner can be reported as a number of tasks performed per unit of time or an amount of time required to perform the task.

Knowing the productivity of various employees in performing tasks of various types allows managers and employers to assign tasks in a way that dramatically improve efficiency of all employees.

The data representing such usage can include, for example, (i) browsing and network traffic history, (ii) change logs in digital documents, and (iii) system log data. Such data typically represents discrete events at a point in time. For example, a browsing history might indicate that the employee clicked on a single link at a specific time. Similarly, a change log in an electronic document might indicate a single change made by the employee at a specific time. The notion of an ongoing, interactive, usage session is abstracted from such discrete events. For example, multiple links selected by the user in a browser within a predetermined frequency can indicate an ongoing, interactive, usage session of a web-based application, particularly if the links are related to one another.

The usage data can be gathered from a computing device used by the employee. The usage data can also be gathered by a server that implements and serves the computer-implemented application over a computer network. In addition, the usage data can be gathered from electronic documents and other data accessed by the employee through a computer network.

### BRIEF DESCRIPTION OF THE DRAWINGS

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims. Component parts shown in the drawings are not necessarily to scale, and may be exaggerated to better illustrate the important features of the invention. In the drawings, like reference numerals may designate like parts throughout the different views, wherein:

FIG. 1 is a diagram showing a server computer that gathers and analyzes usage data from a number of employee devices and network attached storage through a computer network in accordance with one embodiment of the present invention.

FIG. 2 is a logic flow diagram illustrating the manner in which the server computer of FIG. 1 gathers and analyzes usage data from a number of employee devices and network attached storage through a computer network.

FIG. 3 is a block diagram showing in greater detail an employee's device of FIG. 1.

FIG. 4 is a block diagram showing in greater detail the server of FIG. 1.

FIG. 5 is a block diagram of a usage data record used by the server of FIG. 1 to represent usage sessions of a given employee.

FIG. 6 is an application record used by the server of FIG. 1 to represent and identify computer-implemented applications used by the employee.

FIG. 7 is a task category record used by the server of FIG. 1 to represent a category of tasks performed by the employee and to identify applications that belong to that category.

FIG. 8 is an illustrative bar graph showing an employee's productivity over time.

FIG. 9 is an illustrative chart showing an employee's productivity for each of a number of categories of tasks performed by the employee.

### DETAILED DESCRIPTION

As used herein, the term “employee” is not limited to employees in the true legal sense but also includes independent contractors and generally anyone providing a service, whether voluntary or for hire.

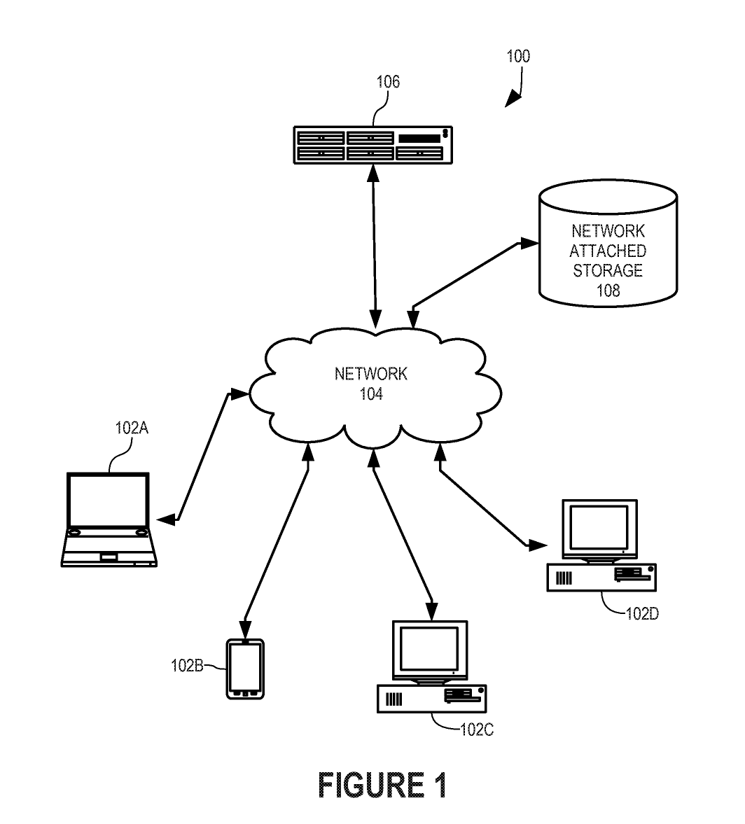

In accordance with the present invention, a server 106 (FIG. 1) gathers usage information from user devices 102A, 102B, 102C, 102D (hereinafter 102A-D) and generates statistical analysis of such usage information to provide an employer with detailed information regarding typical work habits of the respective employees using user devices 102A-D.

Server 106 is a server computer operated by an employer, which can be any hirer of services by employees, contractors, or anyone offering services for hire.

User devices 102A-D each can be any of a number of types of networked computing devices, including smartphones, tablets, netbooks, laptop computers, and desktops computers. Each of user devices 102A-D is assigned to a single employee or, if used by multiple employees, requires authentication by each such employee. In addition, each of user devices 102A-D communicates with server 106 and network attached storage 108 through a network 104. User devices 102A-D are analogous to one another and description of user device 102A is equally applicable to user devices 102B-D unless otherwise noted herein. It should also be noted that, while four (4) user devices are shown in this illustrative example, fewer or more user devices can be used by employees of the employer operating server 106.

Network 104 can be a local area network (LAN), a corporate intranet, a wide area network (WAN) such as the Internet, or a combination thereof. For example, user device 102A can communicate with server 106 through a home LAN, the Internet, and a corporate intranet, perhaps through a virtual private network (VPN).

Network attached storage (NAS) 108 is a networked storage device that stores work and documents produced by employees through use of user device 102A-D. While NAS 108 is shown to be separate from server 106 and user devices 102A-D, it should be appreciated that work and documents stored on NAS 108 can be stored in server 106 and/or in any of user devices 102A-D, either partially or completely, obviating NAS 108 in the latter case.

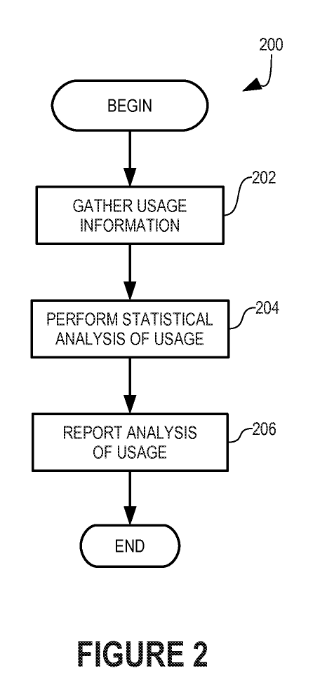

Logic flow diagram 200 (FIG. 2) illustrates the analysis of employee performance performed by server 106, each step of which is described in greater detail below.

In step 202, server 106 gathers data from user devices 102A-D representing usage of the respective user devices by one or more employees.

In step 204, server 106 performs statistical analysis of the usage data.

In step 206, server 106 reports the statistical analysis to one or more managers.

To facilitate appreciation and understanding of the various manners in which server 106 can gather information regarding employee usage of user devices 102A-D, user device 102A and server 106 are described in greater detail.

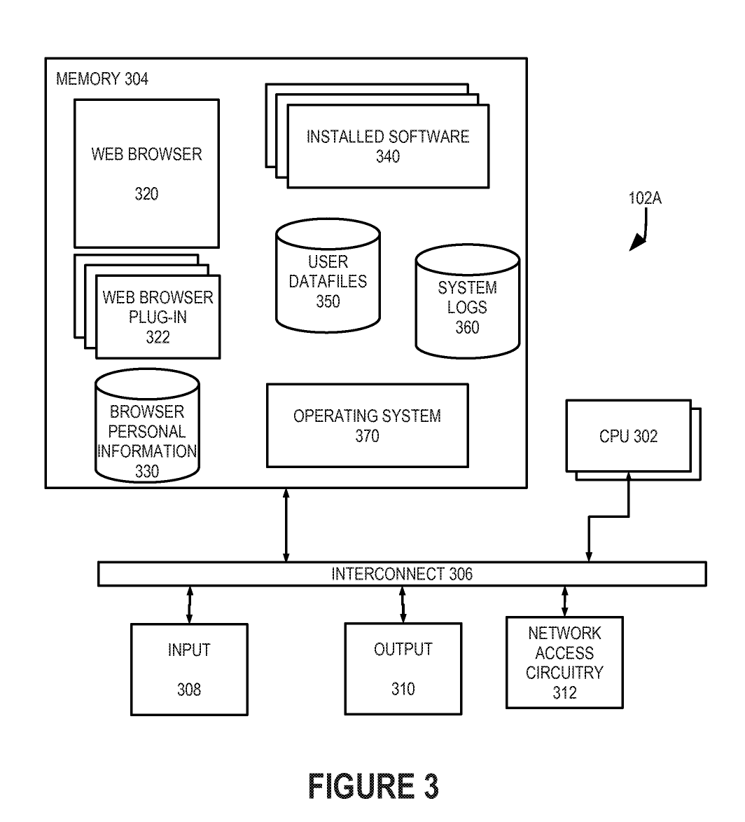

Client device 102A is a personal computing device and is shown in greater detail in FIG. 3. Client device 102A includes one or more microprocessors 302 (collectively referred to as CPU 302) that retrieve data and/or instructions from memory 304 and execute retrieved instructions in a conventional manner. Memory 304 can include generally any computer-readable medium including, for example, persistent memory such as magnetic and/or optical disks, ROM, and PROM and volatile memory such as RAM.

CPU 302 and memory 304 are connected to one another through a conventional interconnect 306, which is a bus in this illustrative embodiment and which connects CPU 302 and memory 304 to one or more input devices 308, output devices 310, and network access circuitry 312. Input devices 308 can include, for example, a keyboard, a keypad, a touch-sensitive screen, a mouse, a microphone, and one or more cameras. Output devices 310 can include, for example, a display—such as a liquid crystal display (LCD)—and one or more loudspeakers. Network access circuitry 312 sends and receives data through computer networks such as wide area network 104 (FIG. 1).

A number of components of client device 102A are stored in memory 304. In particular, web browser 320 is all or part of one or more computer processes executing within CPU 302 from memory 304 in this illustrative embodiment but can also be implemented using digital logic circuitry. As used herein, “logic” refers to (i) logic implemented as computer instructions and/or data within one or more computer processes and/or (ii) logic implemented in electronic circuitry. Web browser plug-ins 322 are each all or part of one or more computer processes that cooperate with web browser 320 to augment the behavior of web browser 320. The manner in which behavior of a web browser is augmented by web browser plug-ins is conventional and known and is not described herein.

Installed software 340 are each all or part of one or more computer processes executing within CPU 302 from memory 304. Operating system 370 is all or part of one or more computer processes executing within CPU 302 from memory 304 and can also be implemented using digital logic circuitry. An operating system (OS) is a set of programs that manage computer hardware resources and provide common services for application software such as installed software 340, web browser 320, and web browser plug-ins 322.

Browser personal information 330, user data files 350, and system logs 360 are persistent data stored in memory 304 and can each be organized as one or more databases. Browser personal information 330 includes data specific to usage of web browser 320, such as browsing history, form data, preferences, bookmarks, and stored passwords, for example. User data files 350 are documents and other files created and edited through any of installed software 340. Examples include word processing documents, spreadsheets, drawings, databases, presentation documents, computer source code, images, video, and audio. System logs 360 include data written by operating system 370 to track usage and performance of user device 102A.

Except as described herein, web browser 320, web browser plug-ins 322, browser personal information 330, installed software 340, user data files 350, system logs 360, and operating system 370 are conventional.

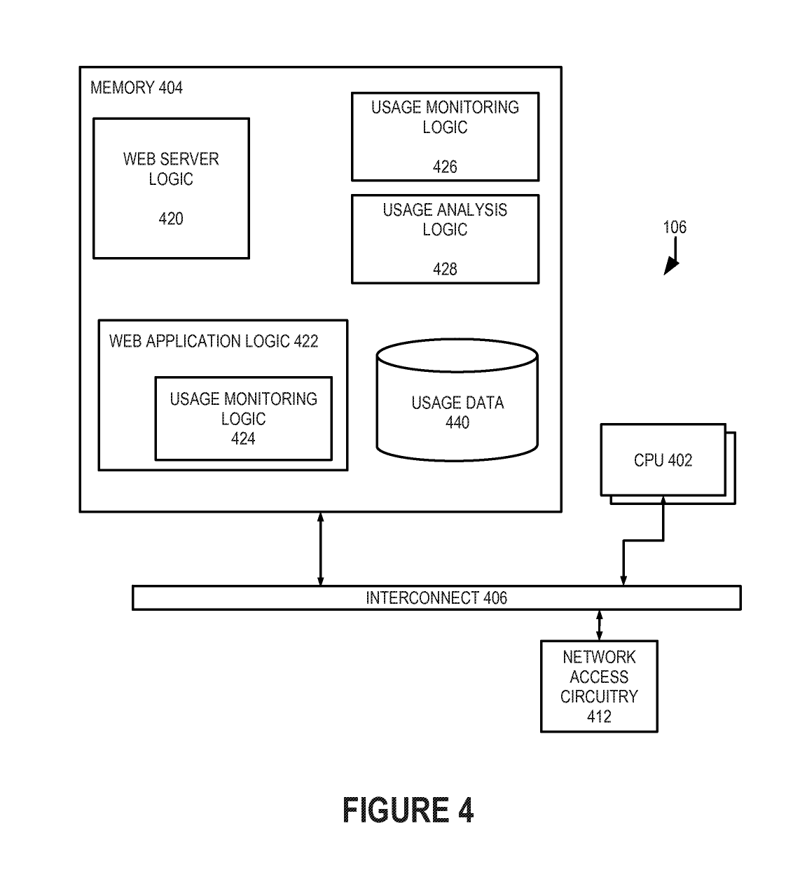

Server computer 106 is shown in greater detail in FIG. 4. Server 106 includes one or more microprocessors 402 (collectively referred to as CPU 402) that retrieve data and/or instructions from memory 404 and execute retrieved instructions in a conventional manner. Memory 404 can include generally any computer-readable medium including, for example, persistent memory such as magnetic and/or optical disks, ROM, and PROM and volatile memory such as RAM.

CPU 402 and memory 404 are connected to one another through a conventional interconnect 406, which is a bus in this illustrative embodiment and which connects CPU 402 and memory 404 to network access circuitry 412. Network access circuitry 412 sends and receives data through computer networks such as wide area network 104 (FIG. 1).

A number of components of server 106 are stored in memory 404. In particular, web server logic 420 and web application logic 422, including usage monitoring logic 424, are each all or part of one or more computer processes executing within CPU 402 from memory 404 in this illustrative embodiment but can also be implemented using digital logic circuitry. Usage monitoring logic 426 and usage analysis logic 428 are also each all or part of one or more computer processes executing within CPU 402 from memory 404 in this illustrative embodiment but can also be implemented using digital logic circuitry.

Usage data 440 is data persistently stored in memory 404 and is organized as one or more databases in this illustrative embodiment.

Web server logic 420 is a conventional web server. Web application logic 422 is content that defines one or more pages of a web site and is served by web server logic 420 to user devices such as user device 102A. Usage monitoring logic 424 is a part of web application logic 422 that gathers usage data from user devices 102A-D in the manner described below. Usage monitoring logic 426 also gathers usage data from user devices 102A-D in the manner described below. Usage analysis 428 performs statistical analysis of the usage data in the manner described below.

There are a number of types of usage information to be gathered and a number of ways the usage information can be gathered.

One type of usage information is web browsing history, such as that represented in browser personal information 330 (FIG. 3). Web browsing history can be gathered in a number of ways.

To the extent server 106 is the server with which web browser 320 interacts, web server logic 420 (FIG. 4) can record such interaction in usage data 440. Web application logic 422 can provide a number of web-based applications that are used by employees of the employer operating server 106. A common term for such web-based applications is “groupware.” Groupware can include calendar applications, e-mail client applications, scheduling applications, task and project management applications, source code versioning systems, and document management systems among others. To the extent web application logic 422 implements such web-based applications, usage monitoring logic 424 can record usage of those applications directly and store data representing such usage in usage data 440.

To the extent server 106 is not the server with which web browser 320 interacts, web browsing history is represented in browser personal information 330 (FIG. 3) and is not generally available to server 106 through web browser 320. To make browser personal information 330 available to server 106, usage monitoring logic 424 (FIG. 4) is caused to execute within user device 102A. Usage monitoring logic 424 can be any of the following: active content to be executed by web browser 320 or a web browser plug-in 322, a web browser plug-in to be installed with web browser plug-ins 322, installed software such as installed software 340, or any combination thereof.

One of the challenges of web browsing activity as representing usage of user device 102A is that HTTP is a stateless protocol. In other words, a single HTTP transaction between web browser 320 and a web server is not considered part of a larger usage session. However, many web servers superimpose a usage session model over many HTTP transactions using cookies for example. Accordingly, a web browser usage session can be detected in the form of multiple HTTP transactions with related URLs within temporal proximity to one another and such detection is bolstered by the existence of a cookie for those related URLs during the session. For example, multiple HTTP transactions involving URLs with domains such as “mail.google.com”, “support.google.com”, “plus.google.com”, “accounts.google.com”, and “www.google.com” within a few minutes of each other can be recognized as a single, ongoing usage session with a web-based mail and personal information application. In addition, the presence of cookies for any of those domains or the parent domain, “google.com”, corroborates the presence of an ongoing usage session.

Another type of usage information is information regarding usage of any of installed software 340. Like usage information in browser personal information 330, usage information regarding installed software 340 is not generally available to server 106 through web browser 320 and is made available to server 106 through execution of usage monitoring logic 424 (FIG. 4) within user device 102A in the manner described above with respect to browser personal information 330.

Installed software 340 can log their usage in user data files 350 or in system logs 360 in places known to usage monitoring logic 424. In addition, operating system 370 can log usage of installed software 340 in system logs 360 in places known to usage monitoring logic 424.

Another type of usage information that reflects usage of installed software 340 or web-based applications is change histories stored in some types of documents stored in user data files 350 or NAS 108 (FIG. 1). For example, some word processing documents, spreadsheets, presentation documents, and other office documents include data representing individual changes to a document made by individual users, including the date and time of such changes. In the manner described above with respect to HTTP sessions, document editing sessions can be inferred from multiple changes made to a given document by a given user within a predetermined temporal proximity of one another.

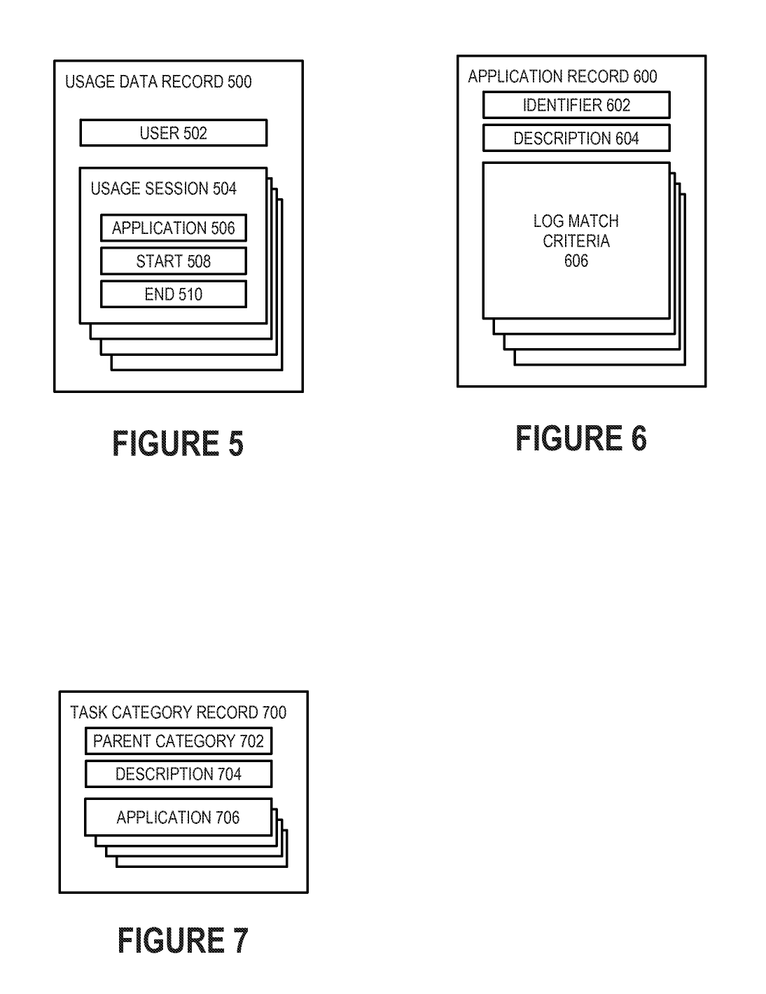

Regardless of the type of usage information gathered and the manner in which it's gathered, usage information for a given user is stored in usage data 440 in the form of usage data record 500 (FIG. 5).

Usage data record 500 includes user 502 and one or more usage sessions 504. User 502 identifies the particular employee whose usage is represented in usage data record 500. That employee is sometimes referred to as the subject employee herein.

Each of usage sessions 504 includes an application 506, a start 508, and an end 510. Application 506 represents the particular application used by the subject employee during the duration of time starting at a time represented by start 508 and ending at a time represented by end 510. Thus, usage sessions 504 represent the various sessions of usage of individual applications by the subject employee.

To map raw usage log data to an application, usage data 440 (FIG. 4) includes a number of application records such as application record 600 (FIG. 6). The particular application represented by application record 600 is sometimes referred to herein as the subject application in the context of FIG. 6. Identifier 602 identifies the subject application uniquely among applications represented within usage data 440 (FIG. 4). Description 604 (FIG. 6) is a description that helps a human identify the subject application. For example, while identifier 602 can be an arbitrary number such as “37”, description 604 should be more intelligible to people, e.g., “OpenOffice.org Document.”

Application record 600 includes log match criteria 606 that is used by usage monitoring logic 426 or usage monitoring logic 424 to determine which usage data pertains to which application. For example, to recognize web browsing history as an ongoing session with a web-based application, log match criteria 606 specifies one or more regular expressions for matching URLs and a predetermined temporal proximity between uses of such URLs to specify the criteria by which a number of HTTP transactions can be inferred to be a single, ongoing session.

As described more completely below, usage analysis logic 428 (FIG. 4) groups usage of various application into tasks performed by the subject employee. Such grouping is performed using task category records stored in usage data 440, such as task category record 700 (FIG. 7). Task category record 700 includes a parent category 702, a description 704, and one or more applications 706. The particular task category represented by task category record 700 is sometimes referred to as the subject task category in the context of FIG. 7.

Parent category 702 identifies a task category of which the subject task category is a sub-category. For example, in a software development service, top level task categories can include “administration” and “development.” Administration can have sub-categories for checking e-mail, checking voice-mail, telephone calls, meetings, time sheets, progress reports, etc. Development can have sub-categories for application design, coding, testing, documentation, and support, for example. And, sub-categories can have sub-categories and so on.

Description 704 is a human-intelligible description of the subject task category.

Applications 706 are identifiers of one or more applications that are considered constituent applications of the subject task category. For example, a task category for processing e-mail can include identifiers of an e-mail client in installed software 340 (FIG. 3) and web-based e-mail clients accessed through web browser 320.

As described above, usage analysis logic 428 (FIG. 4) performs statistical analysis of usage data in step 204 (FIG. 2). There are a large number of ways in which usage data 440 (FIG. 4) can be analyzed statistically. However, two ways are expected to be particularly useful in managing employees.

One type of statistical analysis performed by usage analysis logic 428 (FIG. 4) is a mapping of employee productivity over time. For a given employee, usage analysis logic 428 sums all usage sessions 504 for each of a number of time segments and determines a total percentage of each time segment used by the employee. For example, if usage analysis logic 428 finds usage sessions 504 representing application usage by the employee of 24 minutes during the time segment of 9:00 am to 10:00 am (60 minutes), usage analysis logic 428 determines that the employee was 40% (24 out of 60 minutes) productive during that time segment.

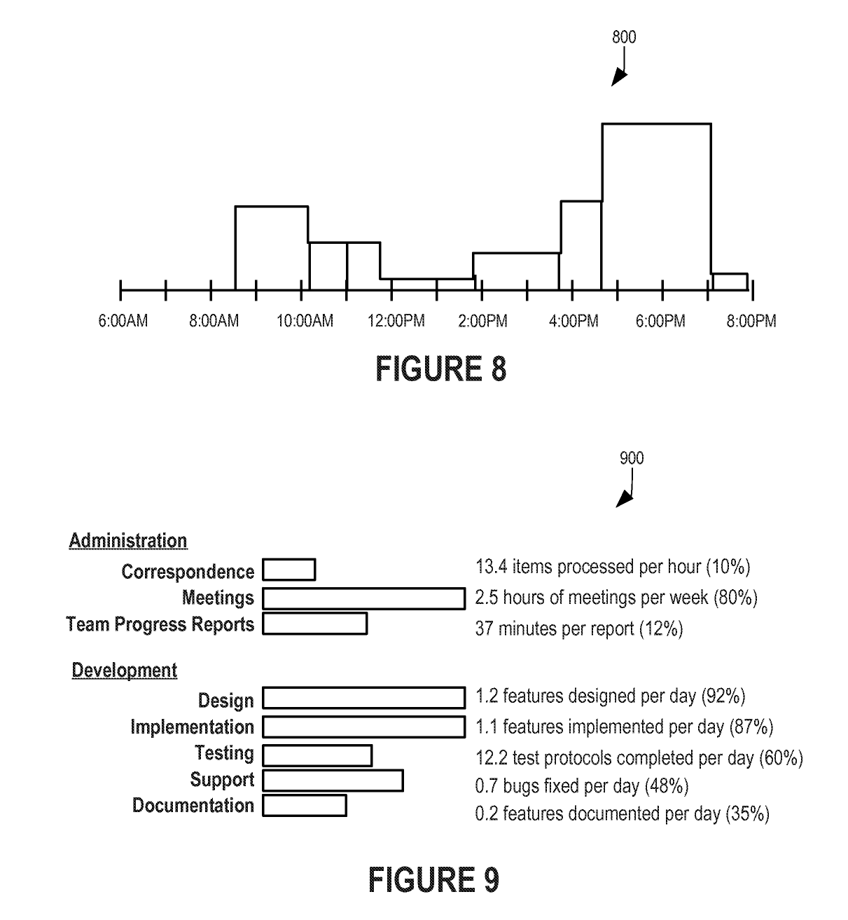

In this illustrative embodiment, usage analysis logic 428 also identifies the task categories of the applications used during each time segment. In reporting this type of analysis in step 206 (FIG. 2), usage analysis logic 428 (FIG. 4) reports both the percentage of productivity and the type of tasks performed during each time segment. An example of such a report in shown as bar graph 800 (FIG. 8). In this illustrative example, bar graph 800 includes bars that have respective heights corresponding to the subject employee's productivity during the corresponding time segment. The color of each bar of bar graph 800 represents a task category. For a time segment in which tasks of multiple categories were performed by the employee, the bar includes multiple colors, e.g., diagonally striped.

As a result, times at which the employee is particularly productive become immediately apparently to a manager viewing bar graph 800. At the same time, the particular task categories for which the employee is not particularly efficient are also immediately apparent by viewing the color(s) of each bar of bar graph 800.

Usage analysis logic 428 can prepare bar graph 800 in the manner described above for any of a number of time schedules. If usage analysis logic 428 aggregates usage by the subject employee for corresponding time segments of all days for which the subject employee has been employed, bar graph 800 represents productivity of the subject employee averaged over the entire term of employment. Usage analysis logic 428 can aggregate usage into separate bar graphs for days of the week, thereby allowing a manager to compare an employee's productivity across days of the week. Usage analysis logic 428 can aggregate usage into separate bar graphs for different months, thereby allowing a manager to observe changes in an employee's productivity schedule over time.

In the illustrative example of bar graph 800, the subject employee is particularly productive in the evening and is not particularly productive at the tasks performed in the middle of the day. The manager can adjust the employee's work schedule and/or environment (perhaps allowing the employee to work at home at times) to take advantage of the employee's productivity in the evening hours. The manager can also reassign the tasks performed by the subject employee during the middle of the day to another employee who appears to be more productive and efficient at those tasks.

Accordingly, with real data regarding productivity of employees over time provides a manager with information that is immediately useful in adjusting work schedules and environments to realize substantial improvements in employee productivity.

Moreover, once changes have been made to the employee's work schedule or environment, usage analysis logic 428 can produce another bar graph representing only application usage since the changes were made, allowing the manager to compare productivity of the employee before and after the changes. Such can cause the manager to make further changes and the process of changes and iterative feedback allow the manager to fine-tune employee work schedules and environments to optimize employee productivity.

Knowing a particular employee's productivity at different times can also be used to increase efficiency of collaboration. Scheduling tools can be configured to automatically schedule meetings and telephone conferences at times when the employee is least productive. Collaboration tools can be configured to suggest collaboration among team members at times when the team members are most productive.

Another type of statistical analysis performed by usage analysis logic 428 (FIG. 4) is a detailed summary of employee productivity for each task category. For a given employee, usage analysis logic 428 uses the productivity determined in the manner described above with respect to bar graph 800 and groups the productivity according to task categories. For example, usage analysis logic 428 collects all time segments of bar graph 800 representing tasks such as processing e-mail and voice-mail and calculates the arithmetic mean as an average productivity of the subject employee for tasks of the category “Correspondence.” Chart 900 (FIG. 9) shows resulting task category productivity for a given employee as reported by usage analysis logic 428.

In addition, usage analysis logic 428 determines productivity on a unit-by-unit basis for each task category. For example, if the subject employee completes a team progress report using a web-based application within web-based application logic 422 (FIG. 4), usage monitoring logic 426 receives data from web application logic 422 representing an amount of time each employee takes to complete such a report. Usage monitoring logic 426 or usage monitoring logic 424 can also determine the amount of time an employee takes to complete a team progress report by analysis of changes to a word processing document in the manner described above when that document is submitted as, or otherwise identified as, a team progress report. In this illustrative embodiment, usage analysis logic 428 also calculates a relative measure of the productivity of the subject employee relative to other employees and expresses the relative measure as a percentile in parentheses as shown in chart 900 (FIG. 9).

The resulting chart 900 is a highly useful summary of the sorts of tasks at which the subject employee is efficient and at which the subject employee is not efficient. Chart 900 in this illustrative example shows relatively low productivity when the subject employee is engaged in administrative tasks but is much more highly productive when engaged in software development tasks. The subject employee is shown to be one of the slowest at writing team progress reports and one who spends a relatively large amount of time in meetings. A manager reviewing chart 900 can determined that the subject employee would be much more valuable to the employer if the employee was not the team leader but was rather tasked primarily and foremost with design and implementation.

The above description is illustrative only and is not limiting. The present invention is defined solely by the claims which follow and their full range of equivalents. It is intended that the following appended claims be interpreted as including all such alterations, modifications, permutations, and substitute equivalents as fall within the true spirit and scope of the present invention.

What is claimed is:

1. A method for analyzing performance of a person in carrying out tasks of two or more task categories, the method comprising:
retrieving historical usage data representing previous usage by the person of one or more computer-implemented applications, wherein each of the computer-implemented applications is associated with one or more of the task categories;
from the historical usage data, identifying one or more usage sessions of the person during which the person used one of the computer-implemented applications; and
determining a measure of productivity of the person from the usage sessions.

2. The method of claim 1 further comprising:
grouping the usage sessions by time to analyze productivity of the person according to a time schedule.

3. The method of claim 1 further comprising:
grouping the usage sessions by the task categories to which each usage session is associated to analyze productivity of the person according to a type of task being performed.

4. The method of claim 1 wherein the measure of productivity is related to a portion of a unit of time occupied by one or more of the usage sessions of the person.

5. The method of claim 1 wherein the measure of productivity is related to an amount of time required by the person to complete a task of at least one of the task categories.

6. A computer readable medium useful in association with a computer that includes one or more processors and a memory, the computer readable medium including computer instructions that are configured to cause the computer, by execution of the computer instructions in the one or more processors from the memory, to analyze performance of a person in carrying out tasks of two or more task categories by at least:
retrieving historical usage data representing previous usage by the person of one or more computer-implemented applications, wherein each of the computer-implemented applications is associated with one or more of the task categories;
from the historical usage data, identifying one or more usage sessions of the person during which the person used one of the computer-implemented applications; and
determining a measure of productivity of the person from the usage sessions.

7. The computer readable medium of claim 6 wherein the computer instructions are configured to cause the computer to analyze performance of a person in carrying out tasks of two or more task categories by at least also:
grouping the usage sessions by time to analyze productivity of the person according to a time schedule.

8. The computer readable medium of claim 6 wherein the computer instructions are configured to cause the computer to analyze performance of a person in carrying out tasks of two or more task categories by at least also:
grouping the usage sessions by the task categories to which each usage session is associate to analyze productivity of the person according to a type of task being performed.

9. The computer readable medium of claim 6 wherein the measure of productivity is related to a portion of a unit of time occupied by one or more of the usage sessions of the person.

10. The computer readable medium of claim 6 wherein the measure of productivity is related to an amount of time required by the person to complete a task of at least one of the task categories.

11. A computer system comprising:
at least one processor;
a computer readable medium that is operatively coupled to the processor;
network access circuitry that is operatively coupled to the processor; and
productivity monitoring and assessment logic (i) that executes at least in part in the processor from the computer readable medium and (ii) that, when executed, causes the processor to analyze performance of a person in carrying out tasks of two or more task categories by at least:
retrieving historical usage data representing previous usage by the person of one or more computer-implemented applications, wherein each of the computer-implemented applications is associated with one or more of the task categories;
from the historical usage data, identifying one or more usage sessions of the person during which the person used one of the computer-implemented applications; and
determining a measure of productivity of the person from the usage sessions.

12. The computer system of claim 11 wherein execution of the productivity monitoring and assessment logic causes the computer to analyze performance of a person in carrying out tasks of two or more task categories by at least also:
grouping the usage sessions by time to analyze productivity of the person according to a time schedule.

13. The computer system of claim 11 wherein execution of the productivity monitoring and assessment logic causes the computer to analyze performance of a person in carrying out tasks of two or more task categories by at least also:
grouping the usage sessions by the task categories to which each usage session is associate to analyze productivity of the person according to a type of task being performed.

14. The computer system of claim 11 wherein the measure of productivity is related to a portion of a unit of time occupied by one or more of the usage sessions of the person.

15. The computer system of claim 11 wherein the measure of productivity is related to an amount of time required by the person to complete a task of at least one of the task categories.
